(19) United States
(12) Patent Application Publication
(10) Pub. No.: US 2006/0077656 A1
(43) Pub. Date: Apr. 13, 2006

(54) Illumination for working machines

(75) Inventor: Tong Huang, Taichung city (TW)

Correspondence Address: BROWDY AND NEIMARK, P.L.L.C.;624 NINTH STREET, NW, SUITE 300, WASHINGTON, DC, 20001-5303, US

(73) Assignee: Hiever Co., Ltd., Taichung City (TW)

(21) Appl. No.: 11/247,131

(22) Filed: Oct. 12, 2005

(30) Foreign Application Priority Data
Oct. 13, 2004 (TW) 93126298

(51) Int. Cl. F21L 4/00

(52) U.S. Cl. 362/189

(57) ABSTRACT

An illumination for working machine of the preferred embodiment of the present invention comprises: a LED light portion that is a casing has a lampshade, a lens, a circuit board and a LED light therein one end and has cave on the other end of the casing. There is a battery set in the casing also to provide the power for the LED light. A adjust portion is a long tube that made by soft material. The adjust portion can be bended to any angle and fixed at that angle. One end of the adjust portion connects to the LED light portion and the other end of the adjust portion has a connecting set thereof. A fix portion has a screw hole at one end and has a pit at the other end with a magnet therein. The adjust portion screws to the fix portion with the threaded section.

### BACKGROUND OF THE INVENTION

1. Field of the Invention

The present invention relates generally to an illumination, and more particularly to an illumination for working machines.

2. Description of the Related Art

Typically, people always need extra illumination when operating a working machine. Most of the illumination apparatus for working machines on the market now were fixed on the working machine. Those illumination apparatus can not be moved or shared and the illumination angle is difficult to adjust. In order word, each of the working machines needs an individual illumination apparatus. These drawbacks cause unnecessary waist and inconvenience to use.

### SUMMARY OF THE INVENTION

The primary objective of the present invention is to provide an illumination, which use for working machines and easy to move, share and adjust.

According to the objective of the present invention, an illumination for working machines comprise a LED light portion with a casing and a LED, a circuit board and a battery set therein. An adjust portion has a tube body which connects with the LED light portion and can be bend to any angle. A fix portion connects with the adjust portion and has a magnet thereon.

### BRIEF DESCRIPTION OF THE DRAWINGS

FIG. 1 is an appearance view of the present invention;

FIG. 2 is an exploded view of the present invention;

FIG. 3 is an illustration showing the using situation of present invention;

### DETAILED DESCRIPTION OF THE INVENTION

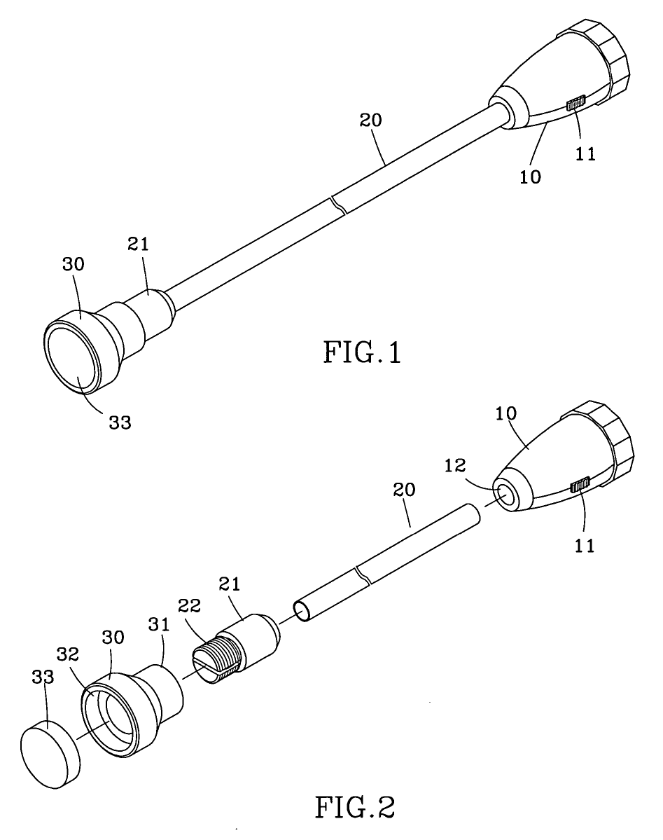

As shown in FIG. 1 to FIG. 2, an illumination for working machines of the preferred embodiment of the present invention comprises:

A LED light portion 10 that is a casing has a lampshade, a lens, a circuit board and a LED light therein one end of the casing. In this embodiment of present invention, the LED light can emit white light for illumination. There is a battery set in the casing also to provide the power for the LED light. There is a switch 11 on the casing and cave 12 on the other end of the casing.

A adjust portion 20 that is a long tube made by soft material. The adjust portion can be bended to any angle and fixed at that angle. In this embodiment of present invention, the adjust portion is a cable with a wire inside. One end of the adjust portion connects to the cave 12 of the LED light portion 10 and the other end of the adjust portion has a connecting set 21 thereof. There is a threaded section 22 at one end of the connecting set.

A fix portion 30 has a screw hole 31 at one end and has a pit 32 at the other end with a magnet 33 therein. The adjust portion screws to the fix portion with the threaded section 22.

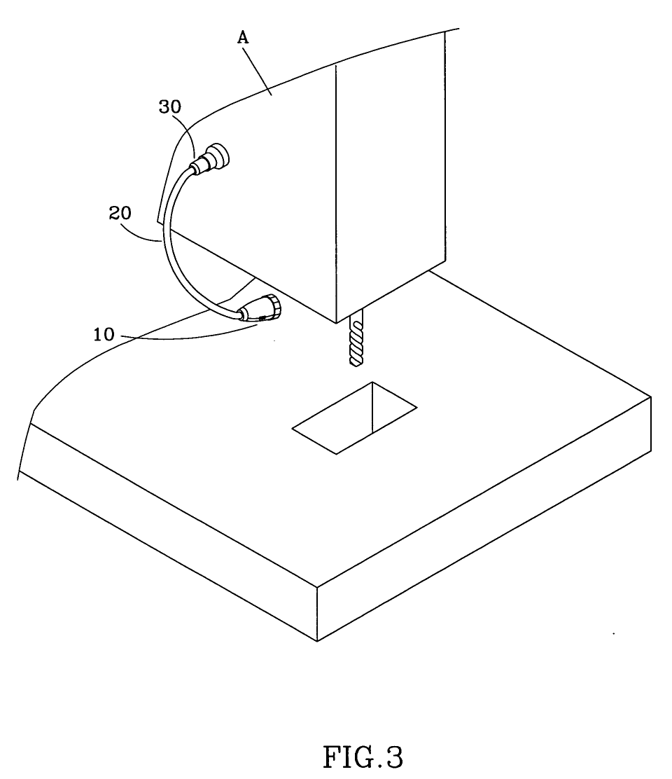

As shows in FIG. 3, the present invention can be fixed on every working machine like a lathe, a drilling machine, a saw machine that has a material board A by the magnet 33. The user can bend the adjust portion 20 to any angle and fix at that angle for the LED light portion 10 to provide better illumination easily. The present invention is lighter than prior art and easy to use and move by using the LED light as a main light source.

What is claimed is:

1. An illumination for working machine, comprising;
a LED light portion that is a casing has lampshade, lens, a circuit board and a LED light therein one end of the casing and a cave on the other end; there is a battery set in the casing also to provide the power of the LED light;
a adjust portion that is a long tube with a wire inside and can be bended to any angle and fixed at that angle; the adjust portion has a connecting set thereof;
a fix portion with a screw hole at one end has a pit at the other end and a magnet therein; the adjust portion screws to the fix portion with the thread of a screw.

2. The illumination for working machine as defined in claim 1, wherein the connecting set has a threaded section at one end.

3. The illumination for working machine as defined in claim 2, wherein the fix portion has a screw hole for the adjust portion screws to the fix portion.
